(19) United States
(12) Patent Application Publication
(10) Pub. No.: US 2026/0196799 A1
(43) Pub. Date: Jul. 9, 2026

(54) LASER SYSTEM, METHOD FOR CREATING AT LEAST ONE SHAPED AND AMPLIFIED LASER BEAM USING A LASER SYSTEM, AND OPTICAL SYSTEM

(71) Applicant: DEUTSCHES ZENTRUM FÜR LUFT- UND RAUMFAHRT E.V., Bonn (DE)

(72) Inventors: Raoul-Amadeus LORBEER, Magstadt (DE); Benjamin EWERS, Böblingen (DE)

(73) Assignee: DEUTSCHES ZENTRUM FÜR LUFT- UND RAUMFAHRT E.V., 53227 Bonn (DE)

(21) Appl. No.: 19/133,076

(22) PCT Filed: Mar. 28, 2024
(86) PCT No.: PCT/EP2024/058516

§ 371 Date: May 27, 2025

(30) Foreign Application Priority Data
Apr. 5, 2023 (DE) 10 2023 108 777.0

(51) Int. Cl. H01S 3/13; H01S 3/00; H01S 3/04; H01S 3/042; H01S 3/06; H01S 3/0941; H01S 3/10

(52) U.S. Cl. CPC H01S 3/1306; H01S 3/0057; H01S 3/0405; H01S 3/042; H01S 3/0604; H01S 3/0941; H01S 3/10061; H01S 3/1305; H01S 3/1307

(57) ABSTRACT

The invention relates to a laser system having a laser radiation source, an optical element and a laser-active amplification device with a first side facing a shaped laser beam and an opposite second side. A beam shaping device is disposed between the laser radiation source and the one optical element and serves to create a laser beam that is shaped with regard to an intensity distribution and/or a phase of the laser beam. The optical element steers the shaped laser beam to the amplification device. The amplification device amplifies the shaped laser beam by means of a pump beam and emits said laser beam as amplified shaped laser beam. The shaped and/or amplified laser beam is diagnosed in order to control and/or regulate the beam shaping device by means of a feedback loop. The invention also relates to an optical system and a method for creating the above type of laser beam.

### BACKGROUND AND SUMMARY

The invention relates to a laser system, in particular a laser amplification system, and a method for creating at least one shaped and amplified laser beam using such a laser system, as well as an optical system.

Laser systems are classified according to their amplification medium into gas lasers, solid-state lasers and dye lasers and emit coherent light in different wavelengths and beam intensities.

The solid-state laser, in particular a disk laser, has a laser source creating a laser beam, an amplification unit with a solid body containing a laser-active material, which amplifies the laser beam impinging on a front side of the solid body, and at least one decoupling unit which couples the amplified beam out of the solid-state laser. Typically, the laser beam passes through the laser-active solid body in several passes, whereby the incident laser beam is reflected at a rear side of the solid body that reflects the laser beam and can exit again from the front side. In order to re-image the emerging laser beam onto the front side of the laser-active solid body, mirror elements are provided, for example.

The laser-active material is typically excited with a pump laser beam created in a pump laser source.

Material processing using laser beams is well known. The following are just a few examples: laser welding for joining different materials such as non-ferrous metals or light metals in component production, laser cutting of sheet metal and laser hardening of surfaces, as well as laser marking and laser cleaning are now established techniques for material processing. For special applications, it is necessary or desirable to have intensities of the created laser beam from a few 10 watts to a few 100 watts available. Furthermore, focused laser beams with a small diameter and at the same time relatively high power are of great interest for special applications. Examples include drilling special holes with diameters of a few 100 nm using laser beams or carving elongated structures in chip production.

High-power lasers are preferred for material processing, taking economic aspects into account. Today, CO₂ lasers and neodymium-YAG lasers are mainly used, in continuous wave (CW) operation as well as in pulsed operation, wherein the operating mode depends on the intended use and the processing method. This also applies to the y laser power, which for CO₂ lasers can typically be up to 10⁶ watts, usually 10³ watts (CW), and 10⁹ watts (pulsed, pulse duration 1 ns, repetition frequency 10 Hz) as well as 200 watts (CW) and 10⁷ watts (pulsed, pulse duration 10 ns to 100 ns, repetition frequency 10⁴ Hz) for neodymium-YAG lasers. The use of ultrashort laser pulses (using titanium-sapphire or ytterbium-YAG lasers) is becoming increasingly important, enabling high edge steepness and reproducibility of the structures produced.

From DE 43 44 227 A1 or DE 198 35 107 A1, laser systems are known which are designed as laser amplification systems and which have a disk-shaped or cuboid-shaped solid body containing laser-active material. In this case, a pump beam is steered onto the laser-active material together with the created laser beam, thus increasing the laser intensity.

It is desirable to provide an improved laser system.

It is also desirable to provide a method for creating at least one shaped and amplified laser beam using such a laser system.

It is also desirable to use a laser system for material processing.

It is also desirable to create an optical system for a laser system, in particular for material processing.

The features listed individually in the claims can be combined with one another in a technologically meaningful manner and can be supplemented by explanatory facts from the description and by details from the figures, wherein further embodiment variants of the invention are shown.

A laser system is proposed, in particular a laser amplification system for creating at least one amplified and/or shaped laser beam, comprising at least one laser radiation source for creating a laser beam, at least one optical element, at least one laser-active amplification device with a first side facing a shaped laser beam and a second side opposite thereto, wherein the laser-active amplification device has in particular a laser-active wedge disk, wherein at least one beam shaping device for creating a laser beam that is shaped with regard to an intensity distribution and/or a phase of the laser beam is arranged between the laser radiation source and the at least one optical element.

The optical element is designed to steer the shaped laser beam onto the laser-active amplification device, wherein the laser-active amplification device is designed to amplify the shaped laser beam by means of a coupled pump beam and to emit it as an amplified shaped laser beam.

The shaped and/or amplified laser beam is diagnosed by means of a measurement device in order to control and/or regulate the beam shaping device by means of a feedback loop.

The at least one shaped laser beam may be a single laser beam or comprise a plurality of separate laser beams, which are arranged in particular at an inclination relative to one another. This applies at least to a laser beam incident on the amplification device. The decoupled laser beam can have both parallel and mutually inclined laser beams.

The laser-active amplification device preferably comprises a laser-active solid body. The laser-active solid body contains a laser-active material.

The laser-active solid body can be in the form of a crystal or glass. For example, the crystal is made of yttrium aluminum garnet or sapphire or a semiconductor.

The laser-active amplification device may comprise a laser-active solid body, wherein the laser-active solid body is doped with the laser-active material. The laser-active solid body can comprise, as laser-active material, a chemical element from the group of lanthanides, in particular yttrium, neodymium and/or erbium, and/or a transition metal, for example titanium and/or zirconium. The laser-active material can be excited by a laser beam called a pump beam. The pump beam typically has a different wavelength than the created laser beam to be amplified and shaped. For example, a created laser beam with a laser wavelength of 1030 nm can be used. The pump beam can have a wavelength of 969 nm as a pump diode.

The pump beam and the shaped laser beam are guided to the amplification device, wherein the amplification device is configured to amplify the shaped laser beam. The shaped laser beam can be guided onto the amplification device once or several times. A shaped, amplified laser beam can be output of the laser system for further use. For example, a created laser beam with a laser wavelength of 1030 nm and a pump beam with a wavelength of 969 nm from a pump diode can be used. Laser wavelengths typically between 700 nm and 3000 nm can be used particularly advantageously for material processing. Typically, pulsed laser beams with a pulse duration of approximately 0.1 ps to several tens of 10 ps can be used, as well as, for example, with a short-pulse laser, with a pulse duration of 10 ps to 10 ns. In particular, pulsed lasers and continuous wave (CW) lasers can be used.

Here, the created laser beam can first be shaped with a lower intensity, typically in the order of a few watts to a few 10 watts, typically 20 watts, and the shaped laser beam can then be amplified by means of the amplification device. An intensity of a few 100 watts, typically 200 watts to 400 watts, can be achieved. The shaped amplified laser beam can then be output of the laser system. This allows a shaped laser beam with increased beam intensity to be achieved for application. Furthermore, the beam shaping device can be used to create multiple individual laser beams, which are then amplified as individual separate laser beams.

This allows a laser beam arrangement with laser beams inclined relative to each other to be created from a laser beam created in the laser radiation source. This laser beam arrangement can be amplified as a whole while maintaining the geometric characteristics of the laser beam arrangement. For example, laser beam arrangements can be provided with a matrix of individual, high-intensity laser beams and output of the laser system.

Such a laser beam arrangement can, for example, be used to simultaneously drill a field of holes in materials. This creates several holes in the material at the same time. This is time-saving and more cost-effective than drilling holes sequentially with a single laser beam. High-intensity line-shaped laser beams can be produced, which are used, for example, to engrave lines in materials such as glass. Structures, in particular 3D structures, can also be incorporated into materials using the laser beam arrangement.

Thus, the shaped laser beam can be a laser beam pattern consisting of or comprising multiple individual laser beams, in particular laser beams inclined to one another, which is formed as a pattern, for example a line, a circle, a polygon, a dot matrix or with another geometric pattern. The individual laser beams can also be directly adjacent to each other. Thus, a continuous structure can be formed as a pattern created by the laser beam arrangement.

By diagnosing the laser beam arrangement, i.e. the amplified and/or shaped laser beam, by means of the measuring device, in particular a camera unit, in order to control and/or regulate the beam shaping device, a particularly advantageously shaped and/or amplified laser beam can be created in a feedback loop. In particular, aberrations that may be caused by the active material of the wedge disk can be corrected and feedback for beam shaping can be provided.

The advantage here is that the created laser beam, which has a low intensity, does not represent any significant load, in particular no significant thermal load, for the beam shaping device while still creating an amplified shaped laser beam of high intensity. Furthermore, intensity losses due to laser beam shaping can be avoided.

In previously known laser systems according to the prior art, the amplified laser beam is subsequently formed into a shaped laser beam after amplification. This results in limitations due to the thermal load capacity of the beam shaping device and limits the intensity of the emitted laser beam or the service life of the beam shaping device used is very short.

The amplified and/or shaped laser beam can be output of the laser system by arranging the amplification device, in particular the wedge disk, at an inclination or by using a decoupling unit with a beam splitter. The decoupling unit may comprise at least one polarization device configured to deflect the laser beam and simultaneously decouple the amplified shaped laser beam. The polarization device is arranged in the beam path of the shaped laser beam, in particular after the optical element and before the amplification device.

Optionally, the laser system may comprise at least one polarization device configured to deflect the laser beam and simultaneously decouple the amplified laser beam.

In a favorable embodiment of the laser system, the measuring device can be or have a camera unit.

Beam adjustment can be done iteratively by comparing an image taken with the camera unit with a “desired” one and forming an error value. This error value can be minimized using a suitable algorithm.

The camera unit can be a classic camera. Furthermore, variants of a classic camera can be used, for example wavefront sensors such as Shack-Hartmann sensors (SHS) or Hartmann sensors; or interferometers such as of the Shearing, Michelson, Mach-Zehnder, Fabry-Pérot, Fizeau, Speckle type; or a multiphase measurement, in particular a heterodyne phase measurement; or a hyperspectral camera, or plenoptic camera (light field camera); or a polarization camera; or by Schlieren imaging; or streak camera and the like.

In principle, “2D” sensors are suitable, which are able to display not only the intensity but also other parameters such as wavelength, polarization, phase, and pulse duration. In addition, such sensors can also be used to implement controls for “spatiotemporal” shaped laser radiation

In an advantageous embodiment of the laser system, the beam shaping device can have at least one spatial modulator for light, in particular a so-called SLM element (SLM=spatial light modulator) and/or at least one diffractive optical element (DOE=diffractive optical element). This allows the phase and/or intensity of the created laser beam to be shaped. By shaping the phase, a spatial modulation can be imposed on the created laser beam, thus creating a geometrically subdivided laser beam. Furthermore, the temporal structure of short laser pulses can be shaped. In general, the laser pulse is first sent through a dispersive element, such as a diffraction grating or a prism, in order to spatially separate the frequency components. With the help of spatial phase modulation, the individual frequency components can now be delayed in time with respect to one another. The division into the individual frequency components can be reversed by steering the light again onto a dispersive element. In principle, completely different pulse shapes can be created depending on the phase modulation.

The diffractive optical element (DOE) is basically a glass substrate onto which microstructuresare applied, for example by photolithography. In the microstructures, phase modulations can occur due to different optical path lengths of the partial beams, resulting in interference patterns. In addition, the amplitude can be modulated by constructive and destructive superposition. Thus, through clever design, the intensity patterns in a laser beam can be manipulated.

DOE elements can perform two tasks: they can form a laser beam or split it into several sub-beams. The microstructure in the DOE element can shape the laser beam through the refractive index or through height modulation. Good components achieve efficiencies of 80%-99% and transmittances of 95%-99%. Imaging errors and/or aberrations of the amplification device can be avoided or at least reduced by suitable diagnostics of the shaped and/or amplified laser beam by means of feedback to the beam shaping device.

Laser beam arrangements, for example a circle of individual laser beams from the created laser beam, can be created. The shaped laser beam can, for example, comprise 20 laser beams. The spatial light modulator (SLM) and/or the diffractive optical element (DOE) can be operated in both transmission and reflection modes. The beam shaping device, for example the spatial modulator (SLM), can be cooled, in particular water-cooled.

In a favorable design of the laser system, the optical element can be a relay optic. In particular, the relay optics can be an optical element that can realize a so-called 4f imaging. The optical element can be divided into two parts and in particular have two lenses which steer the shaped laser beam onto the amplification device.

Preferably, the optical element, in particular the two lenses, can be arranged on the same optical axis as the beam shaping device. The function of the optical element preferably consists in or comprises imaging the shaped laser beam in the amplification device, in particular in imaging the shaped laser beam in its entirety, completely, onto the amplification device.

The 4f setup images the beam shaping element of the beam shaping device as an object onto the amplification device. In a two-lens implementation, the beam shaping element is typically located in the first focal plane of the first lens and the amplifying device is located in the second focal plane of the second lens. Alternatively, the 4f setup can also be implemented with one lens. A distance of two focal lengths in front of the lens and two focal planes after the lens is used to image the beam shaping element.

In a favorable embodiment, a decoupling unit with a beam splitter can be present, which can in particular be designed as a polarizer. In particular, the beam splitter can be designed as a thin-film polarizer. The amplified and/or shaped laser beam can thus be returned in the beam path antiparallel to the laser beam incident on the amplification device and can be advantageously output with the beam splitter of the decoupling unit for further use, for example in material processing.

The beam splitter can be designed as a beam splitter cube or as a beam splitter plate. The beam splitter is an optical component used to split incident light, in particular the laser beam, into two separate beams in a specific ratio. The beam splitter is preferably designed as a polarizing beam splitter, by means of which light can be split into a reflected s-polarized beam and a transmitted p-polarized beam.

Furthermore, polarizing beam splitters are preferably used to split unpolarized light in a 50/50 ratio or to split the polarization states, e.g., in an optical isolator. The beam splitter can also be designed as a non-polarizing beam splitter.

The non-polarizing beam splitter can split light in a specific R/T ratio (reflected portion to transmitted portion) while maintaining the original polarization state. For a 50/50 non-polarizing beam splitter, the beam can be split into a transmitted and a reflected beam with the appropriate beam splitter ratio while maintaining the same P and S polarization state.

In a favorable embodiment, the laser-active amplification device, in particular the laser-active wedge disk, can have at least one coating on the first side, in particular a dichroic coating with properties of a long-pass filter. The dichroic coating can advantageously be a multilayer dielectric coating system, for example silicon oxide glass, such as SiO₂, or tantalum oxide Ta₂O₅ or the like. The effect is that a long-pass filter behavior can be present at the wavelength of the laser radiation to be amplified and/or the pump laser radiation. In operation, this means that a long-pass filter can be realized at the location of the relevant wavelength and angle of incidence (angle range), whereby behavior outside the angle of incidence is not relevant. The properties of the wedge disk are described in DE 10 2016 108 474 A1 and the publication: Lorbeer, R. et al., Monolithic thin-disk laser and amplifier concept, Optica, Opt. Soc. Am., Volume 7, No. 10, pages 1409-1414, October 2020. The contents of both publications concerning the properties and functionality of the wedge disk are expressly included in the description.

The dichroic coating is applied to the surface of the amplifying device, in particular the wedge disk. The dichroic coating has the properties of a long-pass filter. Only the wavelength range of the laser beam is of interest here. The dichroic coating allows both the shaped laser beam and the pump beam to penetrate into the amplification device, in particular the wedge disk.

In a favorable embodiment, the laser-active amplification device, in particular the laser-active wedge disk, can have a reflective, in particular highly reflective, coating on the second side. This can result in multiple reflections of the laser beam in the amplification device. Thus, multiple passes of the amplified shaped laser beam are possible, and there can be multiple amplification passes of the shaped laser beam. It is advantageous if, when operated in reflective mode, the wedge disk is cooled. The second side can serve as a heat sink. The heat dissipation of the reflective coating is selective for angle of incidence and wavelength and can be conveniently adjusted.

In a favorable embodiment, the laser-active amplification device, in particular the laser-active wedge disk, can be inclined at an angle to the incident laser beam, in particular at an angle to a plane of symmetry of the amplification device. The advantage here is that a polarization element in the beam path can be dispensed with.

In a favorable embodiment, a concave mirror can be arranged at a distance from the plane of symmetry of the amplification device and can be designed to reflect the amplified laser beam emitted by the laser-active amplification device back to the laser-active amplification device.

The concave mirror can be arranged so that the shaped laser beam is imaged back onto the amplification device. The concave mirror can advantageously have, for example, a curvature, wherein the spherical center of the curvature can be located behind the first side of the wedge disk and thus in the wedge disk. This means that even with very strong aberrations on the wedge disk, the laser beam can have the same size as before reflection on the concave mirror.

In a favorable embodiment, a wave plate can be arranged in the beam path of the incident and emerging laser beam in front of the concave mirror. This wave plate as a delay plate of the laser beam can, for example, be designed as a quarter-wave plate.

In a favorable embodiment, a planar mirror can be arranged at a distance from the plane of symmetry of the amplification device in the immediate vicinity of the amplification device and can be designed to reflect the amplified shaped laser beam emitted by the amplification device back to the amplification device in a slightly offset manner.

In a favorable embodiment, the planar mirror may have a dielectric coating, in particular a multilayer dielectric coating with properties of a long-pass filter. The same coatings as those of the laser-active amplification device, in particular the laser-active wedge disk, can be used. At steep angles of incidence, the shaped laser beam can be reflected, otherwise transmission can occur. The advantage here is that less distance is covered by the shaped laser beam, which means that the shaped laser beams do not diverge.

In a favorable embodiment, the laser-active amplification device, in particular the laser-active wedge disk, can have a substrate and/or a coating for heat dissipation on the first side. The substrate and/or the coating can serve for heat dissipation. The coating can also be applied to a separate window located in front of the wedge disk.

The window can in particular be wedge-shaped. This allows for good contact pressure to be achieved between the wedge disk and the window. This has the advantage that good heat transfer can be achieved.

In a favorable embodiment, the laser-active amplification device can comprise a material with good thermal conductivity, in particular can be made of the material with good conductivity. A material with good thermal conductivity is understood to have a thermal conductivity greater than copper of 400 W/mK. In particular, the highly conductive material can be diamond and/or aluminum oxide, for example sapphire, and/or cubic boron nitride. The material used must have good transmissivity for the wavelength of the laser beam. One advantage of the thermally highly conductive material, especially diamond, is the heat transport mechanism: In contrast to metals such as copper, which transports heat via conduction electrons, in diamond the heat is transported away by lattice vibrations. The thermal conductivity of diamond is over 1800 W/mK. Thus, diamond has only very little thermal expansion when heated.

In a favorable embodiment, the laser-active amplification device can be arranged on a heat sink. In particular, the wedge disk can be arranged on a heat sink. This allows the irradiated laser power to be dissipated.

According to a further aspect of the invention, a method for creating at least one amplified and/or shaped laser beam with a laser system is proposed, wherein a laser beam shaped by means of a beam shaping device, in particular a laser beam shaped by means of a spatial modulator for light and/or a diffractive optical element, is amplified.

In particular the shaped and/or amplified laser beam is diagnosed by means of a measuring device in order to control and/or regulate the beam shaping device by means of a feedback loop.

Advantageously, aberrations caused by the active medium of the laser-active amplification device can be compensated and feedback for the beam shaping can be provided.

In a favorable embodiment, a laser-active amplification device, in particular a laser-active wedge disk, can be used for amplification.

In a favorable embodiment, the measuring device with which the amplified and/or shaped laser beam is diagnosed by means of a measuring device can be a camera unit in order to control and/or regulate the beam shaping device. In this way, a particularly favorably shaped and/or amplified laser beam can be created in a feedback loop. This means that the shaped and/or amplified laser beam can be used advantageously for material processing, for example.

The method for creating a shaped and amplified laser beam can use the laser beam by means of a spatial modulator for light, in particular a so-called SLM element, and/or at least one diffractive optical element (DOE) for shaping, wherein the shaped laser beam is subsequently amplified. The amplification can be carried out by means of a laser-active amplification device which, in particular, has a laser-active wedge disk with at least one dichroic coating on a first side facing the shaped laser beam to be amplified.

An advantage of the method is the effective creation of a shaped and amplified laser beam, in particular a pulsed shaped laser beam with reduced overall losses. Furthermore, the thermal load on the beam shaping device can be reduced.

According to a further aspect of the invention, a use of the laser system according to the invention for material processing is proposed. Preferably, the laser system can be used for geometric material processing, such as material removal, joining and/or incorporating patterns into a workpiece in one operation. Here, a pattern is created in one operation using the shaped, amplified laser beam. For example, an array of n x m holes can be drilled on a surface using the shaped laser beam, where n and m each denote the number of laser beams of the shaped laser beam. By using the laser beam with a short pulse length, the lateral projection around the drilled hole can be reduced.

According to a further aspect of the invention, an optical system is proposed, in particular for creating at least one amplified and/or shaped laser beam. The optical system comprises at least one optical element, at least one laser-active amplification device, in particular a laser-active wedge disk, with a first side intended to face a shaped laser beam and a second side opposite thereto. At least one beam shaping device is disposed on the input side in front of the at least one optical element and serves to create a laser beam that is shaped with regard to an intensity distribution and/or a phase of the laser beam. The optical element is designed to steer the shaped laser beam properly onto the laser-active amplification device.

The optical element is designed to amplify the shaped laser beam properly by means of a coupled pump beam and to emit it as an amplified shaped laser beam.

In particular a measuring device is provided, in particular a camera unit, by means of which the amplified and/or shaped laser beam is diagnosed, in order to control and/or regulate the beam shaping device by means of a feedback loop.

Advantageously, the optical system can be coupled to a laser and a pump beam source in order to shape and amplify the laser beam of the laser.

The proposed optical system comprises a beam shaping device, an optical element, an amplification device and an output coupling unit of the previously described laser system. The laser beam can be created externally and imaged onto the optical system by means of optical elements, in particular onto the beam shaping device. The laser-active material of the amplification device can be activated by means of an externally created pump beam, which is imaged onto the amplification device and excites the laser-active material.

### BRIEF DESCRIPTION OF THE DRAWINGS

Further advantages will be apparent from the following description of the drawings. Exemplary embodiments of the invention are shown in the figures. The figures, the description, and the claims contain numerous features in combination. A person skilled in the art will expediently also consider the features individually and combine them into further meaningful combinations.

Exemplarily, in the following figures:

FIG. 1 shows an exemplary embodiment of a laser system;

FIG. 2 shows the laser system of FIG. 1 with a camera device;

FIG. 3 shows a schematic representation of a wedge disk;

FIG. 4 shows a schematic representation of the wedge disk of FIG. 3 in isometric view;

FIG. 5 shows a schematic representation of a beam path in the plane A-A from FIG. 1;

FIG. 6 shows a schematic representation of a beam path in the plane A-A from FIG. 1;

FIG. 7 shows a schematic representation of a beam path in the plane A-A from FIG. 1 for a further embodiment of the laser system;

FIG. 8 shows a schematic representation of a beam path in the plane A-A from FIG. 1 for a further embodiment of the laser system;

FIG. 9 shows a schematic representation of a material processing.

### DETAILED DESCRIPTION

In the figures, identical or identically acting components are identified by the same reference numerals. The figures only show examples and are not to be understood as limiting.

Before the invention is described in detail, it should be pointed out that it is not limited to the respective components of the device and the respective method steps, since these components and methods can vary. The terms used herein are only intended to describe particular embodiments and are not used in a limiting manner. Furthermore, if the singular or indefinite articles are used in the description or in the claims, this also applies to the plural of these elements, unless the overall context clearly indicates otherwise.

The directional terminology used in the following with terms such as “left”, “right”, “above”, “below”, “in front of”, “behind”, “after”, and the like only serves for better comprehension of the figures and is in no way intended to restrict the generality. The components and elements shown, their configuration and use can vary according to the considerations of a person skilled in the art and can be adapted to the respective applications.

The laser beam in the following exemplary embodiments may be a single laser beam or comprise a plurality of separate laser beams, which in particular are inclined to one another. This applies at least to a shaped laser beam incident on the amplification device. The output laser beam can have both parallel and mutually inclined laser beams.

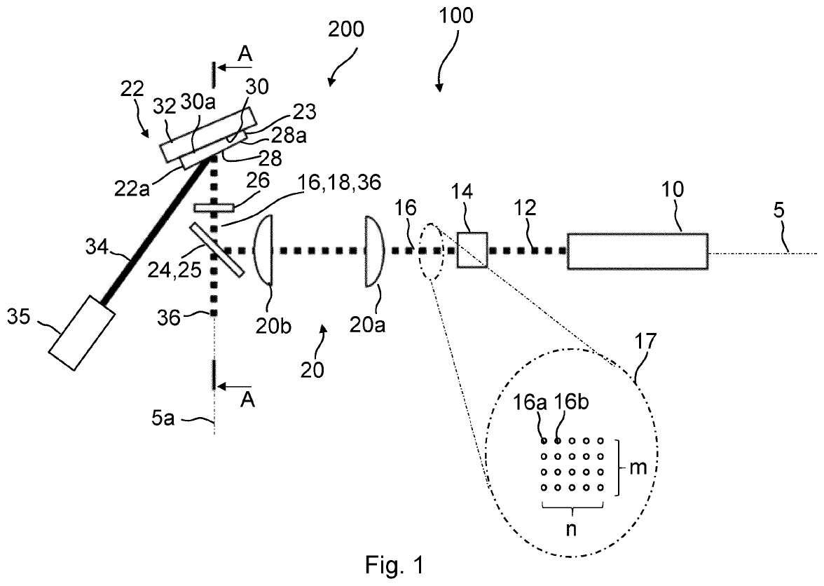

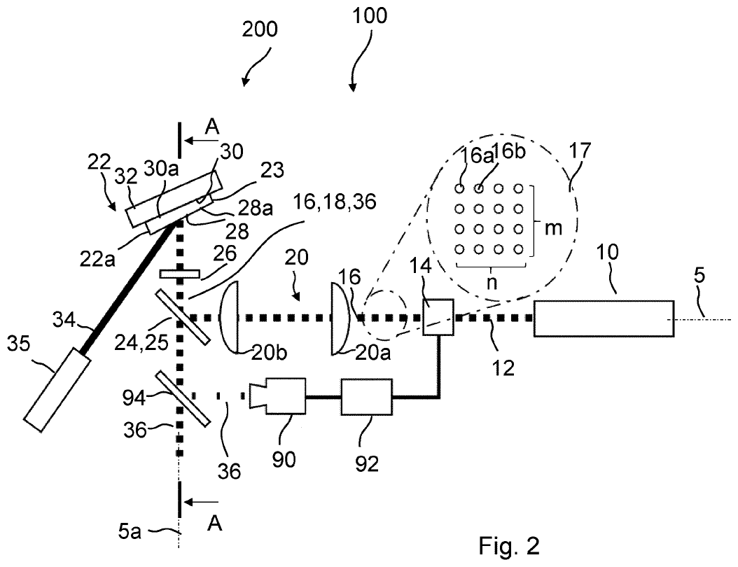

FIG. 1 shows a schematic representation of a laser system 100, in particular a laser amplification system 100. FIG. 2 shows the laser system 100 with an exemplarily arranged measuring device 90.

The laser system 100 has a laser radiation source 10. The laser radiation source 10 creates a laser beam 12. The laser radiation source 10 can create a pulsed laser beam 12. The pulsed laser beam 12 typically has a wavelength between 700 nm and 3000 nm. The pulsed laser 10 typically has a pulse length of between 0.1 ps and a few 10 ps. These are typical laser beams used for material processing. The laser beam 12 has a Gaussian intensity profile.

The laser system 100 has a beam shaping device 14 which is arranged downstream of the laser radiation source 10. The beam shaping device 14 is an optical element which is configured to form a shaped laser beam 16 from the created laser beam 12.

The beam shaping device 14 is, for example, a spatial modulator for light. The beam shaping device 14 can also be a diffractive optical element (DOE). The beam shaping device 14 can modulate the created laser beam 12 in phase and/or intensity. The laser beam 16 formed by the modulation then has a changed intensity profile.

The shaped laser beam 16 is, for example, a laser beam arrangement 17 divided into several separate laser beams 16a, 16b, . . . by the beam shaping device 14. The laser beam arrangement 17 has n×m individual laser beams 16a, 16b, . . . in a matrix-like arrangement, where n and m are integers greater than zero. For example, the laser beam arrangement 17 may have twenty individual laser beams 16a, 16b, . . . This is shown in the figure in an inset as an enlargement. The totality of the individual laser beams 16a, 16b, . . . forms the laser beam arrangement 17. By means of the laser beam arrangement 17 with twenty individual laser beams, for example, twenty holes can be drilled simultaneously in a workpiece (not shown).

The shaped laser beam 16 may also have any pattern of individual laser beams and is then referred to as laser beam arrangement 17.

The individual laser beams 16a, 16b, . . . in the shaped laser beam 16 can be spaced apart from one another in the laser beam arrangement 17 and/or the shaped laser beam 16.

The individual laser beams 16a, 16b, . . . in the shaped laser beam 16 can also not be spaced apart from one another in the laser beam arrangement 17 and/or the shaped laser beam 16. For example, by means of non-spaced laser beams 16a, 16b, . . . in the shaped laser beam 16, a solid line can be impressed on a workpiece by means of the shaped laser beam.

Downstream of the beam shaping device 14 is an optical element 20 which steers, in particular images, the shaped laser beam 16 onto an amplification device 22. The optical element 20 typically has two lenses 20a, 20b and is preferably designed as a relay optic.

The laser radiation source 10, the beam shaping device 12 and the optical element 20 are arranged on an optical axis 5. The laser beam 12 and the shaped laser beam 16 thus propagate along the optical axis 5.

The shaped laser beam 16 is guided to the amplification device 22. In this case, a beam splitter 24 can be provided in the beam path of the laser beam 16. The beam splitter 24 can be designed as a polarizer. This can be, for example, a thin-film polarizer. The shaped laser beam 16 is deflected in the polarizer, passes through a wave plate 26, in particular a quarter-wave plate or quarter-wave plate 26, and strikes the amplification device 22 along an optical axis 5a.

Laser radiation source 10, beam shaping device 14, optical unit 20 with the two lenses 20a, 20b, and the beam splitter 24 are arranged along the first optical axis 5. Beam splitter 24, wave plate 26 and amplification device 22 are arranged along the second optical axis 5a, in which the amplified and shaped laser beam 36 is also output.

The amplification device 22 is also referred to as laser-active amplification device 22. The amplification device 22 comprises a laser-active material, preferably in the form of a laser-active solid body. The laser-active solid body can be in the form of a crystal or glass. For example, the crystal is made of yttrium aluminum garnet or sapphire or a semiconductor. The laser-active amplification device 22 may comprise a laser-active solid body, wherein the laser-active solid body is doped with the laser-active material. The laser-active solid body can herein comprise, as laser-active material, a chemical element from the group of lanthanides, in particular yttrium, neodymium and/or erbium, and/or a transition metal, for example titanium and/or zirconium.

The laser-active material can be excited by a laser beam called a pump beam 34.

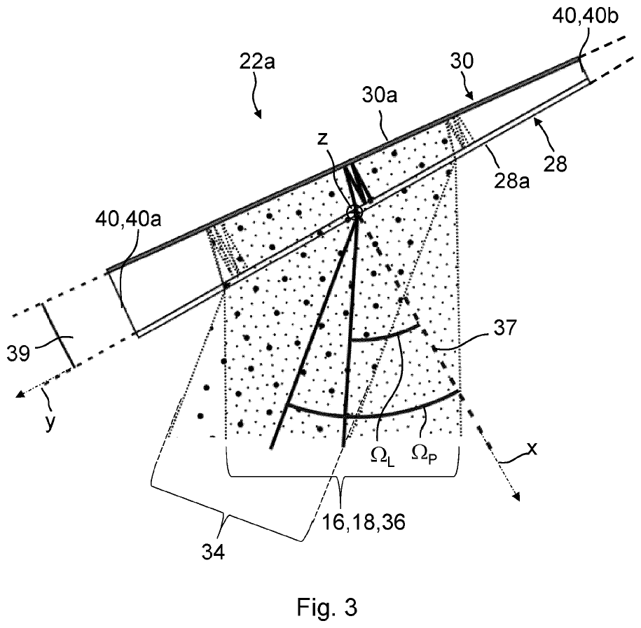

The amplification device 22 in the exemplary embodiment shown in FIG. 1 has at least one wedge disk 22a. The wedge disk 22a has a laser-active material 23. The wedge disk 22a has on a first side 28 a first boundary surface with a coating 28a which faces the incident laser beam 16. The wedge disk 22a can, for example, have thicknesses of a few 0.1 mm up to 2 mm and a diameter of 4 mm up to 30 mm. Furthermore, the wedge disk 22a has on a second side 30 a second boundary surface with a second reflective coating 30a, which faces away from the laser beam 16. The reflective coating 30a is preferably a highly reflective coating 30a. The first coating 28a and the second coating 30a are arranged substantially opposite one another. The first and second sides 28, 30 of the wedge disk 22a are not arranged parallel to each other, but enclose a wedge angle 39 (FIG. 3). The laser-active material 23 is arranged between the first side 28 and the second side 30.

The wedge disk 22a is typically arranged on a support element 32. Typically, the support element 32 represents a heat sink. The support element 32 comprises, for example, diamond. A dichroic coating 28a is applied to the first side 28. The dichroic coating 28a is in particular a dielectric layer. The dichroic coating 28a has high-refractive index and low-refractive index layers, in particular metal oxide layers. The dichroic coating 28a can advantageously be a multilayer dielectric coating system, for example silicon oxide glass, such as SiO₂, or tantalum oxide Ta₂O₅ or the like. The dichroic coating 28a has the properties of a long-pass filter near the pump and laser wavelength.

By means of the reflective layer 30a, the laser beam 16 is reflected at the second side 30 and leaves the wedge disk 22a through the first side 28. This makes it possible to realize several amplification passes for the shaped laser beam 16.

Furthermore, a pump beam unit 35 creating a pump beam 34 is provided. The pump beam 34 is typically a CW laser beam 34. The pump beam 34 is directed onto the first side 28 of the wedge disk 22a and is configured to excite and energize the laser-active material 23 of the wedge disk 22a to drive the amplification process. Furthermore, an optical device (not shown) may be provided which steers the pump beam 34 onto the amplification device 22.

The amplified, shaped laser beam is designated by reference numeral 36. The amplified, shaped laser beam 36 passes through the quarter-wave plate 26 and the polarizer 24 and can be output for use. The amplified, shaped laser beam 36 may advantageously also comprise the laser beam arrangement 17.

The beam shaping device 14 is also configured, in addition to beam shaping, to compensate for the aberrations typically created by the wedge disk 22a by suitable prior beam shaping. The laser beam 36 therefore has a good beam quality. The focusability of lasers according to ISO standard 11146-1-2021-11 is described by the diffraction coefficient M². This indicates the divergence angle of a laser beam relative to the divergence of an ideal Gaussian beam with the same diameter at the beam waist. A good beam quality is indicated by a small M², preferably less than 2. This means that the laser beam 36, in particular any individual laser beams of the laser beam 36, are not expanded and/or widened.

The polarizer 24, the wave plate 26 and the wedge disk 22a are arranged on the optical axis 5a. The laser beam 36 is output along the optical axis 5a.

The beam splitter 24, in particular a polarizer, represents a decoupling unit 25 which is configured to output the amplified, shaped laser beam 36. The decoupling unit 25 may have other optical elements not shown.

The beam shaping device 14, the optical element 20, the amplifying device 22 and the decoupling unit 25 form an optical system 200 into which the laser beam 12 and the pump beam 34 can be steered.

FIG. 3 shows the wedge disk 22a in a schematic sectional drawing. The wedge disk 22a has a substantially flat wedge disk body. The wedge disk body can be viewed in a coordinate system shown in the figure.

The wedge disk body has a substantially equal thickness 40 in a longitudinal direction along the z-axis, wherein the thickness 40 varies in a transverse direction along the y-axis. Typical thicknesses 40 for the wedge disk 22a are a few 10 μm to a few 100 μm. The reference numeral 37 designates a normal to the first side 28 of the wedge disk 22a, which lies in the x-axis of the coordinate system. A wedge angle 39 denotes the angle at which the first side 28 and the second side 30 are inclined relative to each other. The wedge angle 39 can, for example, be 1 degree.

A portion of the shaped and amplified laser beam 36 is steered into the measuring device 90 shown in FIG. 2 via a beam splitter 94 and diagnosed by means of the measuring device 90. The measuring device 90 can, for example, be a camera unit. An evaluation unit 92 is connected to the measuring device 90 and acts back on the beam shaping device 14. The evaluation unit 92 allows the beam shaping device 14 to be controlled and/or regulated with a feedback loop. Thus, aberration errors, which arise in particular from the active material of the wedge disk 22a, can be corrected and feedback for the beam shaping can be provided.

FIG. 3 shows the wedge disk 22a and the arrangement relative to the laser beam 16 and the pump laser beam 34. An angle of incidence Ω_{P} of the pump laser beam 34 to the normal 37 of the wedge disk 22a is typically greater than an angle of incidence Ω_{L} of the shaped laser beam 16 to be amplified. The pump beam 34 is indicated by large dots and the shaped and/or amplified laser beam 16, 18, 36 is indicated by small dots.

The first side 28 has the dichroic coating 28a, which allows the pump laser beam 34 and the shaped laser beam 16 to penetrate the surface of the wedge disk 22a.

The dichroic coating 28a is advantageously constructed as a multilayer coating and has multiple layers. As a result, a dielectric layer system with the properties of a long-pass filter is realized on the first side 28.

In the figure, reflections on the second side 30 of the wedge disk 22a are indicated within the wedge disk 22a. The wedge angle 39 reduces the new angle of incidence on the dichroic coating 28a during reflection. This makes it possible for the reflection and transmission behavior of multilayer dielectric systems to shift towards longer wavelengths. This effect can be taken into account when designing the wedge disk 22a for the laser wavelength used.

If the dichroic coating 28a is designed with long-pass behavior near the laser wavelength, this means that the beams 16 and 34 are nearly completely reflected. Thus, the laser beam 16 and the pump beam 34 are trapped in the wedge disk 22a for multiple reflections, allowing multiple amplification passes.

The respective angle of incidence Ω_{L} and Ω_{P} decreases further with increasing amplification passes. This continues until the angle of incidence Ω_{L} and Ω_{P} are almost perpendicular to the first side 28 and/or the second side 30 of the wedge disk 22a. During the subsequent amplification pass of the laser beam 16, the angle of incidence Ω_{L}, Ω_{P} increases again until the laser beam 16 and the pump beam 34 pass through the dichroic coating 28a and exit from the first side 28 of the wedge disk 22a.

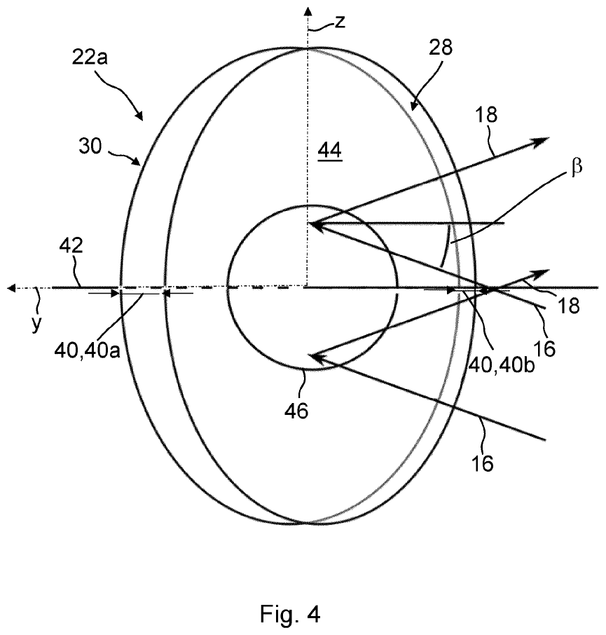

FIG. 4 shows the wedge disk 22a in an isometric view in an oblique top view of the first side 28 of the wedge disk 22a. The view is perspective and along the pump beam 34. A plane of symmetry 42 is arranged perpendicular to the first side 28 of the wedge disk 22a and thus perpendicular to a wedge surface 44. The plane of symmetry 42 runs in the y-axis along the greatest change in the thickness 40 of the wedge disk 22a. The z-axis extends along the direction of constant thickness 40. The plane of symmetry 42 divides the wedge disk 22a into an upper half and a lower half.

In FIG. 4, a side of greatest thickness 40a and a side of smallest thickness 40b, which lie in the plane of symmetry 42, can be seen. Typically, a maximum thickness 40a can have a value of up to 2 mm and a minimum thickness 40b can have a value of a few 0.1 mm.

The circular region represents the laser-active part of the wedge disk 22a.

The following describes how a laser beam 16 hits the first side 28 of the laser-active wedge disk 22a and is reflected. If the unamplified but shaped laser beam 16 is irradiated at an angle β relative to the plane of symmetry 42 at the angle of incidence Ω_{L}, it penetrates the first side 28, is reflected on the second side 30 by the reflective layer 30a and leaves the wedge disk 22a, in particular after multiple reflection in the wedge disk 22a, again through the first side 28 as a reflected beam 18 offset by the angle β and mirrored at the plane of symmetry 42. The totality of the laser beams 18 leaving the wedge disk 22a are referred to as laser beams 36 when they are output of the laser system 100. The laser beams 36 are shaped and amplified laser beams, see also the description of FIG. 1.

Thus, the reference numeral 18 designates a singly amplified and shaped laser beam 18. Thus, the reference numeral 18a designates a singly amplified and shaped laser beam 18a after reflection, in particular multiple reflection, at the rear side 30.

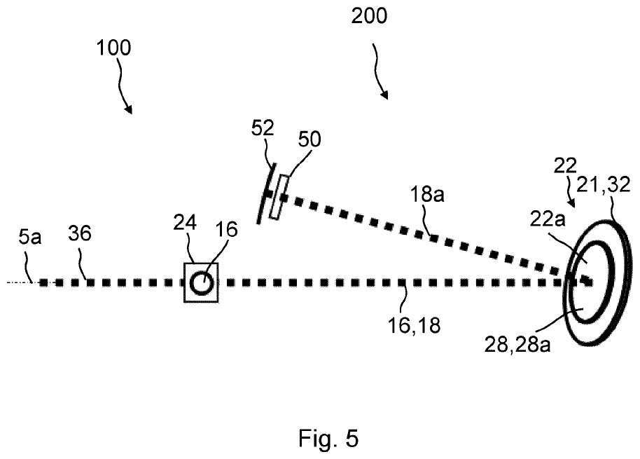

FIG. 5 shows a schematic representation of the laser system 100 in a plan view from the direction of the laser radiation source 10 in the plane A-A of FIG. 1. The illustration shows a double passage of the laser beam 16 through the wedge disk 22a and thus a double amplification. In the figure, the wedge disk 22a is inclined upwards at an angle to a plane of symmetry 42 of the amplification device 22 (FIG. 4). The inclination of the disk can advantageously lead at least partially to a rotation around the y-axis (FIG. 3).

It can be seen that the wedge disk 22a is arranged on a substrate 21 or support element 32. The substrate 21 is preferably a heat sink. The substrate 21 can also be actively cooled.

The shaped laser beam 16 hits the polarizer 24, for example, at an angle of 45° or the Brewster angle and is steered onto the wedge disk 22a. After amplification, which may be in the range of approximately 20, the laser beam 18a passes through a wave plate 50, in particular a quarter-wave plate, and is reflected by a concave mirror 52 and imaged onto the wedge disk 22a. The shaped and doubly amplified laser beam 36 is output. The concave mirror 52 has a curvature, the spherical center of the curvature being located behind the first side 28 of the wedge disk 22a and thus in the wedge disk 22a. As a result, the laser beam 18, 18a can have the same size as before reflection at the concave mirror 52, even in the case of very strong aberrations on the wedge disk 22a. Furthermore, aberrations that are negated in point reflections, for example tilting or coma, can also be suppressed.

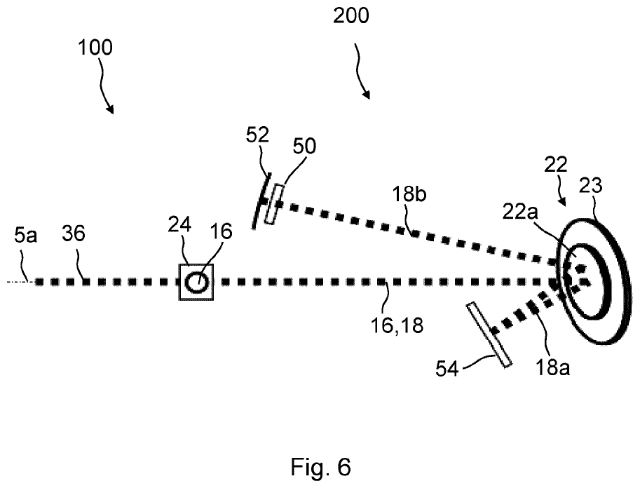

FIG. 6 shows a schematic representation of the laser system 100 for a shaped laser beam 16 with four-fold amplification pass from the viewpoint of the laser source 10 (plane A-A of FIG. 1). In addition to the components shown in FIGS. 1 and 5, the laser system 100 has a planar mirror 54 which is arranged in the immediate vicinity of the wedge disk 22a. The wedge disk 22a is inclined downwards in the figure. The wedge disk 22a is in particular inclined at an angle to the incident shaped laser beam 16. The wedge disk 22a is arranged at an angle to the plane of symmetry 42 of the amplification device 22 (FIG. 4). The planar mirror 54 enables the laser beam 18a incident on the wedge disk 22a to be reflected slightly offset. The offset can be a fraction of the laser beam diameter. The laser beam 18b exits at an unspecified angle and can be projected back onto the wedge disk 22a by the concave mirror 52. This allows additional amplification passages to be realized without any significant offset.

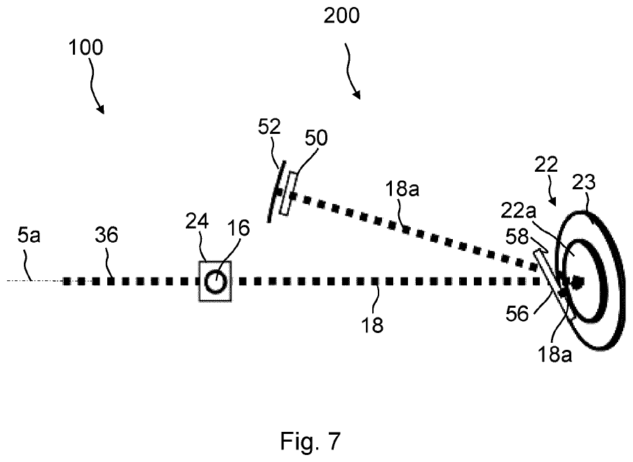

FIG. 7 shows the laser system 100 in a schematic representation from the perspective of the laser source 10 (plane A-A of FIG. 1). In addition to the components shown in FIGS. 1 and 5, a mirror 56 with a dichroic coating 58 is arranged in close proximity to the wedge disk 22a. The dichroic coating 58 exhibits the behavior of a long pass. The dichroic coating 58 is applied to the side of the mirror 56 which faces the wedge disk 22a. The reflection of the laser beam 18a at the dichroic coating 58 makes it possible to minimize the offset of the laser beam 18, 18a. This has the advantage that the laser beam 18, 18a can be transmitted by the mirror 56 at a large angle of incidence. Furthermore, the laser beam 18, 18a can be reflected back onto the wedge disk 22a in a slightly tilted manner at an almost vertical angle of incidence. This allows a beam geometry similar to that achieved with a quadruple pass, with the mirror 56 being arranged even closer to the wedge disk 22a than in the embodiment shown in FIG. 6.

This means that the beam offset can be reduced even further. The pump beam 34 can be transmitted by the dichroic coated mirror 56 at a given angle of incidence.

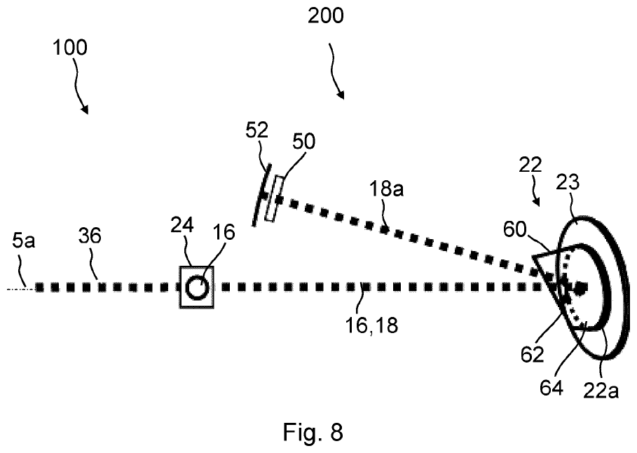

FIG. 8 shows the laser system 100 in a schematic representation from the perspective of the laser source 10 (plane A-A of FIG. 1). In addition to the components of the laser system 100 shown in FIGS. 1 and 5, a wedge-shaped substrate 60 is shown. The wedge-shaped substrate 60 is made of a material with good thermal conductivity. The thermally highly conductive material has a thermal conductivity in the range of 1800 W/mK, in particular greater than 1800 W/mK. The wedge-shaped substrate 60 is preferably made at least partially of diamond and/or an aluminum oxide, preferably sapphire. The wedge-shaped substrate 60 has a side facing the laser beam 16 with a dichroic coating 62. The dichroic coating 62 is a dielectric coating and exhibits the behavior of a long-pass filter at the laser wavelength and/or at the pump wavelength.

An inclination angle of the wedge-shaped substrate 60 is designed such that the wedge-shaped substrate 60 can be pressed directly against the first side 28 of the wedge disk 22a. A heat sink is realized by the direct contact between the wedge-shaped substrate 60 and the first side 28 of the wedge disk 22a.

In addition, an increased angle of inclination can also be used to combine the function of the mirror 56 with dichroic coating 58 (FIG. 7) with the heat-conducting function of the wedge-shaped substrate 60.

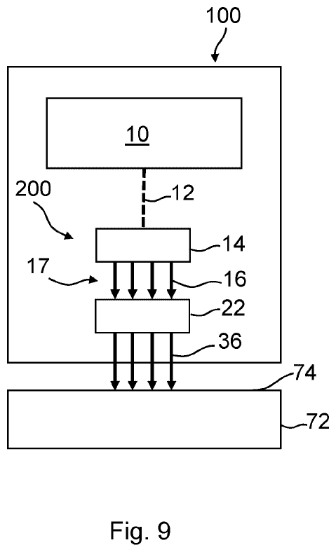

FIG. 9 shows a schematic representation of the use of the laser system 100 with a laser beam arrangement 17 (FIG. 1) with decoupled laser beams 36 for processing a workpiece 72.

From the laser beam arrangement 17, a laser beam 36 with corresponding individual laser beams is directed onto a surface 74 of a workpiece 72 to be machined. The surface 74 can be machined in one operation. Machining here means: drilling holes, in particular an arrangement of holes, drawing lines, cutting 3D structures into the surface 74. Other processing operations not described in detail here are also included in the use, as long as they use a laser beam 36 which is composed of several partial laser beams. The simultaneous processing of a workpiece 72 with the laser beam arrangement 17 is time-efficient and enables, for example, greater processing accuracy since the work steps do not have to be carried out one after the other.

### LIST OF REFERENCE NUMERALS

5 optical axis
5a optical axis
10 laser beam source
12 laser beam
14 beam shaping device
16 shaped laser beam
16a, 16b shaped laser beam
17 laser beam arrangement
18 shaped laser beam
18a amplified laser beam
20 optical element
20a, 20b lenses
21 substrate
22 amplification device
22a wedge disk
23 laser-active material
24 beam splitter
25 decoupling unit
26 wave plate
28 first side
28a dichroic coating
30 second side
30a reflective coating
32 support element
34 pump beam
35 pump beam unit
36 shaped and amplified laser beam,
36a, 36b partial beams of the shaped and amplified laser beam
37 normal
39 wedge angle
40 thickness of the wedge disk
40a smallest thickness
40b greatest thickness
42 plane of symmetry
44 wedge surface
46 circular region
50 wave plate
52 concave mirror
54 planar mirror
56 planar mirror
58 dichroic coating
60 wedge-shaped substrate
62a dichroic coating
64 heat sink
72 workpiece
74 surface
90 measuring device
92 evaluation unit
94 beam splitter
100 laser system
200 optical system
β angle to the plane of symmetry of the amplification device
Ω_{L} angle of incidence of the laser beam
Ω_{P} angle of incidence of the pump beam
x, y, z axes of a coordinate system

1. A laser system, comprising:
at least one laser radiation source for generating a laser beam
at least one optical element
at least one laser-active amplification device with a first side facing a shaped laser beam and a second side opposite thereto,
wherein a beam shaping device is disposed between the laser radiation source and the one optical element and serves to create a laser beam that is shaped with regard to an intensity distribution and/or a phase of the laser beam,
wherein the optical element is designed to direct the shaped laser beam onto the laser-active amplification device,
wherein the laser-active amplification device is designed to amplify the shaped laser beam by means of a coupled pump beam and to emit it as an amplified shaped laser beam,
wherein the shaped and/or amplified laser beam is diagnosed by means of a measuring device in order to control and/or regulate the beam shaping device by means of a feedback loop.

2. The laser system according to claim 1, wherein the measuring device has a camera unit.

3. The laser system according to claim 1, wherein the beam shaping device has at least one spatial modulator for light and/or at least one diffractive optical element.

4. The laser system according to claim 1 wherein the optical element is a relay optic.

5. The laser system according to claim 1 wherein there is a decoupling unit with a beam splitter.

6. The laser system according to claim 1 wherein the laser-active amplification device has at least one coating on the first side.

7. The laser system according to claim 1 wherein the laser-active amplification device has a reflective coating on the second side.

8. The laser system according to claim 1 wherein the laser-active amplification device is inclined at an angle to the incident laser beam.

9. The laser system according to claim 1 wherein a concave mirror is arranged at a distance from a plane of symmetry of the amplification device and is designed to reflect the amplified, shaped laser beam emitted by the amplification device back to the amplification device wherein the concave mirror is arranged such that the laser beam is again imaged onto the amplification device.

10. The laser system according to claim 9, wherein a wave plate is arranged in the beam path of the incident laser beam and emerging laser beam in front of the concave mirror.

11. The laser system according to claim 9, wherein a planar mirror is arranged at a distance from the plane of symmetry of the amplification device in the immediate vicinity of the amplification device and is designed to reflect the amplified laser beam emitted by the amplification device back to the amplification device in an offset manner.

12. The laser system according to claim 1, wherein the laser-active amplification device has a substrate and/or a coating for heat dissipation on the first side.

13. The laser system according to claim 1, wherein the laser-active amplification device comprises a material with good thermal conductivity.

14. The laser system according to claim 1, wherein the laser-active amplification device is arranged on a heat sink

15. A method for generating at least one amplified and/or shaped laser beam with a laser system according to claim 1,
amplifying a laser beam shaped by means of a beam shaping device and
diagnosing the amplified and/or shaped laser beam is diagnosed by means of a measuring device, in order to control and/or regulate the beam shaping device by means of a feedback loop.

16. The method according to claim 15, wherein a laser-active amplification device is used for amplification.

17. The method according to claim 15, wherein the measuring device comprises a camera unit.

18. A method comprising use of a laser system according to claim 1 for material processing of workpieces

19. An optical system comprising:
at least one optical element
at least one laser-active amplification device with a first side properly facing a shaped laser beam and a second side opposite thereto,
wherein at least one beam shaping device is disposed on the input side in front of the at least one optical element and serves to create a laser beam that is shaped with regard to an intensity distribution and/or a phase of the laser beam (40),
wherein the optical element is designed to steer the shaped laser beam onto the laser-active amplification device,
wherein the laser-active amplification device is designed to properly amplify the shaped laser beam by means of a coupled pump beam and to emit it as an amplified shaped laser beam,
wherein a measuring device is provided, with which the amplified and/or shaped laser beam is diagnosed in order to control and/or regulate the beam shaping device by means of a feedback loop.
